(19) United States
(12) Patent Application Publication
(10) Pub. No.: US 2021/0094362 A1
(43) Pub. Date: Apr. 1, 2021

(54) TIRE AND RIM ASSEMBLY

(71) Applicant: Sumitomo Rubber Industries, Ltd., Kobe-shi (JP)

(72) Inventors: Masaki TERASHIMA, Kobe-shi (JP); Kenji UEDA, Kobe-shi (JP); Masaya ITO, Kobe-shi (JP); Koji HAYASHI, Kobe-shi (JP); Ryo OBA, Kobe-shi (JP); Masahiro NAGASE, Kobe-shi (JP); Masatomo NAKAMURA, Kobe-shi (JP); Junya TAMAI, Kobe-shi (JP); Masahiro TATSUTA, Kobe-shi (JP)

(73) Assignee: Sumitomo Rubber Industries, Ltd., Kobe-shi (JP)

(21) Appl. No.: 17/027,254

(22) Filed: Sep. 21, 2020

(30) Foreign Application Priority Data
Sep. 30, 2019 (JP) 2019-180271

(51) Int. Cl. B60C 15/024; B60B 7/06; B60C 15/06

(52) U.S. Cl. CPC B60C 15/0242; B60C 2015/0614; B60C 15/06; B60B 7/063

(57) ABSTRACT

A tire and rim assembly includes a rim having a pair of flanges, and a pneumatic tire being mounted onto the rim, the pneumatic tire including a pair of bead portions and a rim guard being provided on at least one of the pair of bead portions. In a cross-sectional view of the assembly under a standard state, the rim guard protrudes outwardly in a tire axial direction from a sidewall reference outer surface of the tire so as to cover over one of the pair of flanges. An angle θ of an imaginary rim guard straight line with respect to a tire radial direction is equal to or less than 40 degrees, and a maximum gap (A) in the tire radial direction between the one of the pair of flanges and the rim guard is equal to or less than 2.0 mm.

### BACKGROUND ART

### Field of the Disclosure

The present disclosure relates to a tire and rim assembly.

### Description of the Related Art

The following Patent document 1 discloses a pneumatic tire mounted on a rim. The pneumatic tire mounted on the rim comprises an outboard sidewall forming a tire width equal to the maximum tire width near rim flanges of the rim, and the outboard sidewall is formed by a curve or a straight line such that the tire width decreases from the maximum width position to the tread portion.

### PATENT DOCUMENT

[Patent document 1] Japanese Unexamined Patent Application Publication S63-247104

### SUMMARY OF THE DISCLOSURE

In the pneumatic tire of Patent Document 1, there was room for improvement in reducing air resistance of the tire to improve fuel efficiency.

The present disclosure has been made in view of the above circumstances and has a main object to provide a tire and rim assembly capable of reducing air resistance.

In one aspect of the disclosure, a tire and rim assembly includes a rim having a pair of flanges, and a pneumatic tire being mounted onto the rim, the pneumatic tire including a pair of bead portions, a carcass extending between the pair of bead portions, and a rim guard being provided on at least one of the pair of bead portions, wherein in a cross-sectional view of the assembly under a standard state in which the pneumatic tire is inflated to a standard pressure but loaded with no tire load, the rim guard protrudes outwardly in a tire axial direction from a sidewall reference outer surface of the tire so as to cover over one of the pair of flanges located on the at least one of the bead portions, the rim guard defines an axially outermost end thereof a radially outermost end thereof, and an imaginary rim guard straight line that passes the axially outermost end and the radially outermost end, an angle θ of the imaginary rim guard straight line with respect to a tire radial direction is equal to or less than 40 degrees, and a maximum gap (A) in the tire radial direction between the one of the pair of flanges and the rim guard is equal to or less than 2.0 mm.

In another aspect of the disclosure, the angle θ may be equal to or less than 35 degrees.

In another aspect of the disclosure, in a cross-sectional view of the assembly, the rim guard may include a rim guard surface that corresponds to the imaginary rim guard straight line.

In another aspect of the disclosure, the rim guard may include a rim guard surface that is a concave circular are surface being concave inwardly in the tire radial direction with respect to the imaginary rim guard straight line.

In another aspect of the disclosure, a radius of curvature of the concave circular are surface of the rim guard may be in a range of 100 to 300 mm.

In another aspect of the disclosure, the maximum gap (A) may be equal to or less than 1.5 mm.

In another aspect of the disclosure, the pair of bead portions includes a pair of bead cores, the carcass includes a main portion extending between the pair of bead cores and a pair of turn-up portions turned up around the pair of bead cores from axially inside to outside of the tire, and the axially outermost end of the rim guard may be located inward in the tire radial direction with respect to a radially outer end of one of the pair of turn-up portions located on a side of the at least one of the bead portions.

In another aspect of the disclosure, the radially outermost end of the rim guard may be located outward in the tire radial direction with respect to the radially outer end of one of the turn-up portions.

In another aspect of the disclosure, in the at least one of the bead portions, a bead apex rubber that extends outwardly in the tire radial direction from the bead core is disposed, and the axially outermost end of the rim guard may be located inward in the tire radial direction with respect to a radially outer end of the bead apex rubber.

In another aspect of the disclosure, on the at least one of the bead portions, a first gauge of rubber disposed outside in the tire axial direction of the carcass at a location of the axially outermost end of the rim guard may be equal to or less than three times a second gauge of rubber disposed outside in the tire axial direction of the carcass at a location of the radially outermost end of the rim guard.

### BRIEF DESCRIPTION OF THE DRAWINGS

FIG. 1 is a cross-sectional view of a tire and rim assembly according to the present disclosure;

FIG. 2 is an enlarged view of a bead portion and a sidewall portion of FIG. 1;

FIG. 3 is a schematic horizontal-sectional view of the tire and rim assembly installed to a vehicle;

FIG. 4 is a front view of the vehicle of FIG. 3;

FIG. 5 is a cross-sectional view of the bead portion and the sidewall portion of FIG. 1; and

FIG. 6 is a cross-sectional view of the bead portion according to another embodiment of the disclosure.

### DESCRIPTION OF THE PREFERRED EMBODIMENTS

An embodiment of the present disclosure will be explained below with reference to the accompanying drawings.

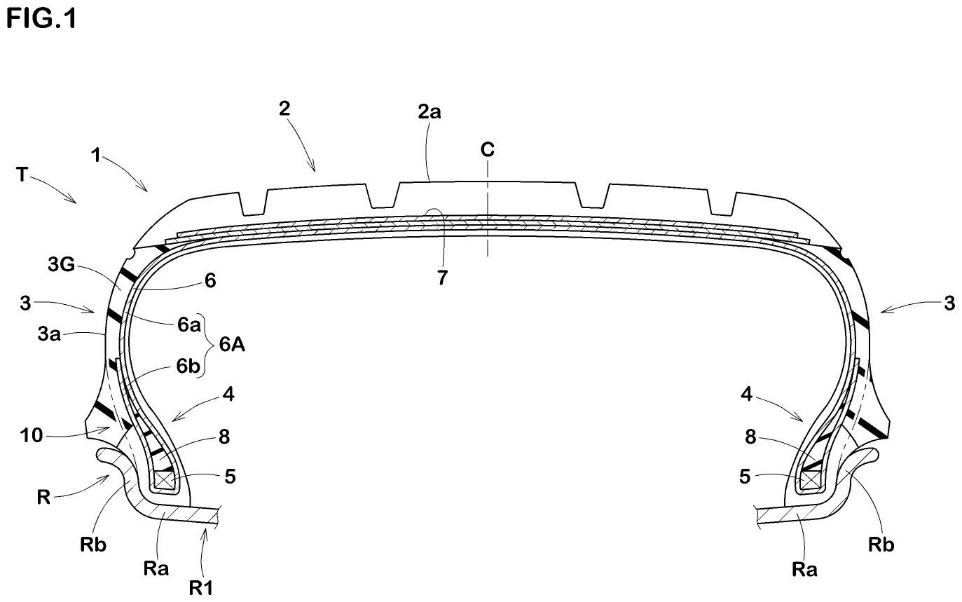

FIG. 1 is a cross-sectional view of a tire and rim assembly (hereinafter simply referred to as “assembly”) T under a standard state according to an embodiment of the disclosure. The cross-sectional view of FIG. 1 is a cross sectional view including the tire axis (not illustrated). As illustrated in FIG. 1, the assembly T according to the present embodiment includes a rim R, and a pneumatic tire (hereinafter simply referred to as “tire”) 1. In FIG. 1, as the tire 1, a passenger car tire is illustrated, for example. Note that the tire 1 according to the disclosure can be embodied as a motorcycle tire, a heavy-duty vehicle tire and the like.

The rim R according to the present embodiment includes a pair of rim seats Ra for receiving a pair of bead portions 4 of the tire 1, and a pair of flanges Rb connected to respective axially outer ends of the pair of rim seats Ra and extending outwardly in a tire radial direction. The pair of flanges Rb, for example, supports axially outer surfaces of the pair of bead portions 4. The rim R, in the present embodiment, is a standard wheel rim RI that is officially approved for the tire 1 by standards organizations on which the tire 1 is based, wherein the standard wheel rim RI is the “standard rim” specified in JATMA, the “Design Rim” in TRA, and the “Measuring Rim” in ETRTO, for example.

As used herein, the “standard state” is such that the tire 1 is mounted onto the standard wheel rim R with a standard pressure but loaded with no tire load. Unless otherwise noted, dimensions of the assembly T are measured in the standard state.

As used herein, the “standard pressure” is a standard pressure officially approved for each tire by standards organizations on which the tire is based, wherein the standard pressure is the “maximum air pressure” in JATMA, the maximum pressure given in the “Tyre Load Limits at Various Cold Inflation Pressures” table in TRA, and the “Inflation Pressure” in ETRTO, for example.

The tire 1, for example, includes a tread portion 2 having a ground contact surface 2a that comes into contact with the ground, a pair of sidewall portions 3 extending inwardly in the tire radial direction from respective axially outer ends of the tread portion 2, and the pair of bead portions 4 connected to the pair of sidewall portions 3 and having respective bead cores 5 disposed therein.

The tire 1 according to the present embodiment may further include a carcass 6 extending between the pair of bead portions 4, and a belt layer 7 disposed outwardly in the tire radial direction of the carcass 6 in the tread portion 2. Furthermore, the tire 1 may include a pair of bead apex rubbers 8 made of hard rubber composition and disposed outwardly in the tire radial direction of the pair of bead cores 5, and a pair of sidewall rubbers 3G forming outer surfaces 3a of the pair of sidewall portions 3. As to the bead cores 5, the belt layer 7, the bead apex rubbers 8 and the sidewall rubbers 3G, conventional aspects are appropriately adopted.

The carcass 6, in the present embodiment, is composed of a single carcass ply 6A. The carcass ply 6A, for example, includes a plurality of carcass cords that are oriented at an angle of 75 to 90 degrees with respect to the tire equator C and topping rubber to coat the carcass cords.

The carcass ply 6A, for example, includes a main portion 6a and a pair of turn-up portions 6b. The main portion 6a, for example, extends between the bead cores 5 in a toroidal manner. The turn-up portions 6b, for example, are connected to the bead main portion 6a and are turned up around the bead cores 5 from axially inside to the outside of the tire.

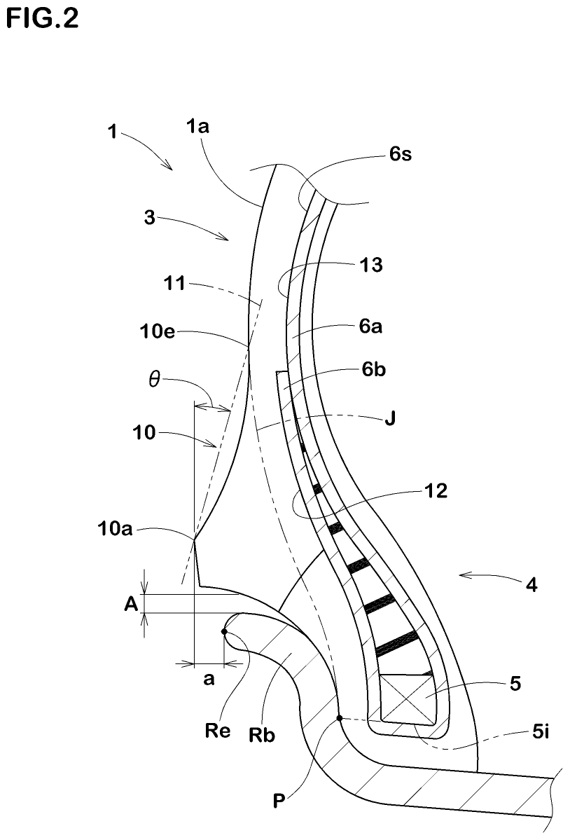

FIG. 2 is an enlarged view of the bead portion 4 and the sidewall portion of the left side of FIG. 1. As illustrated in FIG. 2, the tire 1 according to the present embodiment further includes a rim guard 10 provided on at least one of the pair of bead portions 4. In the present embodiment, the rim guard 10 is provided on either side of the bead portions 4. Each rim guard 10 protrudes outwardly in the tire axial direction from a respective sidewall reference outer surface J of the tire 1 so as to cover over the flange Rb on either side of the bead portions 4. Further, each rim guard 10 according to the present embodiment extends continuously in the tire circumferential direction.

As used herein, the sidewall reference outer surfaces J is an imaginary outer surface of the sidewall portion 3 when no rim guard is provided. Specifically, the sidewall reference outer surfaces J is obtained by moving an outer contour line 6s of the carcass ply 6A onto a reference point P along the tire axial direction. Further, the reference point P is a point on an outer surface 1a of the tire 1 at a location of a radially inner end 5i of the bead core 5. As the outer contour line 6s, the outer surface 12 of the turn-up portion 6b shall be adopted. In the area where the turn-up portion 6b is not provided (e.g., the area outside the tire radial direction than the turn-up portions 6b), the outer surface 13 of the main portion 6a shall be adopted as the outer contour line 6s.

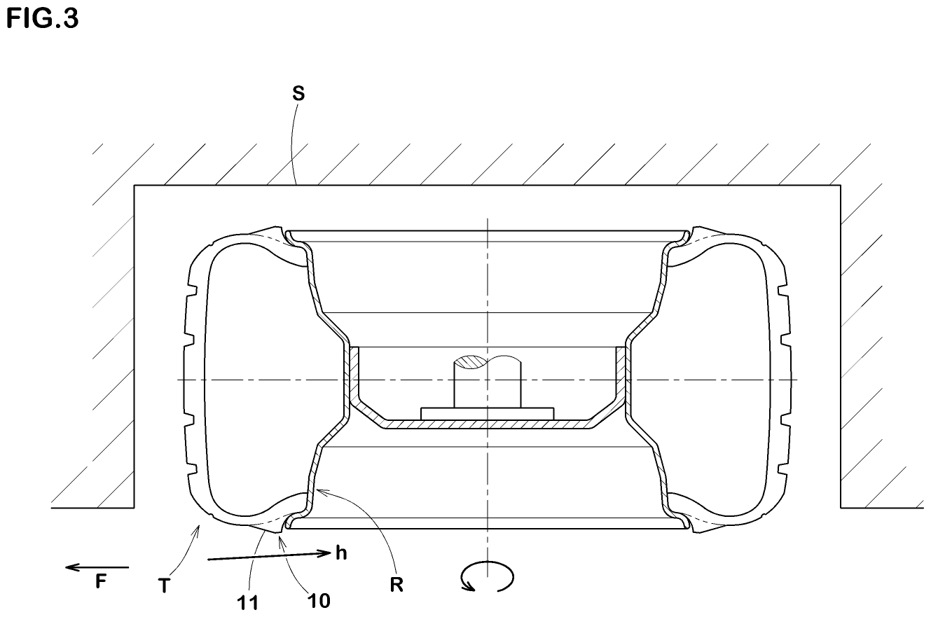

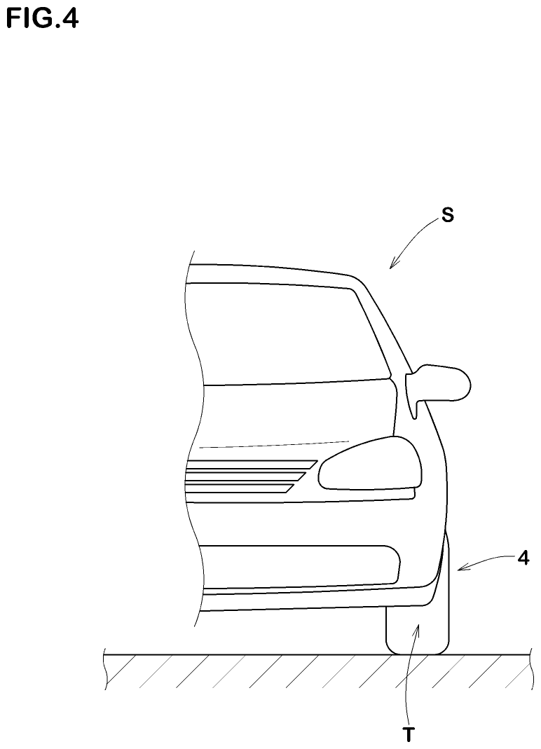

FIG. 3 is a schematic horizontal-sectional view of the assembly T installed to a vehicle S. FIG. 4 is a half front view of the vehicle of FIG. 3. Note that the arrow F indicates a traveling direction of the vehicle S. As illustrated in FIG. 3 and FIG. 4, on the outboard of the vehicle, the vicinity of the bead portion 4 may be exposed to the outside of the vehicle S. In the present embodiment, as shown in FIG. 2, an angle θ of an imaginary rim guard straight line 11 with respect to the tire radial direction is equal to or less than 40 degrees. Here, the imaginary rim guard straight line 11 is a straight line that passes an axially outermost end 10a of the rim guard 10 and the radially outermost end 10e of the rim guard 10. As a result, resistance of the air (h) flowing from a surface of the imaginary rim guard straight line 11 toward the rim R when the vehicle S runs can be reduced. Note that when the axially outermost end 10a of the rim guard 10 forms a plurality of locations on the rim guard 10 in the tire radial direction, the axially outermost end 10a is defined as one that is located outermost in the tire radial direction. Further, if the outer contour line 6s of the carcass ply 6A does not connect with an outer surface 1a of the tire 1, the radially outermost end 10e of the rim guard 10 is defined as the position where the outer contour line 6s and an outer surface 1a of the tire 1 are closest to each other.

As illustrated in FIG. 2, a maximum gap (A) in the tire radial direction between the flange Rb and the rim guard 10 is equal to or less than 2.0 mm. As a result, the air passing through the surface of the imaginary rim guard straight line 11 is suppressed from flowing between the flange Rb and the rim guard 10, reducing air resistance. Thus, in the assembly T according to the present embodiment, the specific angle θ and maximum gap (A) can work together to reduce resistance of the air flowing on the surface of the rim guard 10, improving fuel efficiency. Note that the maximum gap (A) is measured as a radial distance from a radially outermost point of the rim flange Rb to the rim guard.

In order to further improve the above-mentioned effect, the angle θ is preferably equal to or less than 35 degrees, more preferably equal to or less than 30 degrees. When the angle θ becomes excessively small, the boundary layer of air flowing on the surface of the rim guard 10 is likely to peel off, which may increase air resistance. Further, when the angle θ becomes excessively small, the radially outermost end 10e of the rim guard 10 tends to be located relatively outward in the tire radial direction, and volume of the rim guard 10 becomes large, which may deteriorate rolling resistance. Thus, the angle θ is preferably equal to or more than 5 degrees.

The maximum gap (A) is preferably equal to or less than 1.5 mm. This can further suppress the air flow between the flange Rb and the rim guard 10. When the maximum gap (A) becomes excessively small, the rim guard 10 and the flange Rb are in intimate contact with each other upon traveling, and the rim guard 10 may be damaged, which may increase air resistance. Thus, the maximum gap (A) is preferably equal to or more than 1.0 mm.

Preferably, the axially outermost end 10a of the rim guard 10 is located at the same position in the tire axial direction as the axially outermost end Re of the flange Rb, or beyond the axially outermost end Re of the flange Rb outwardly in the axial direction. Thus, when the air passing through the surface of the imaginary rim guard straight line 11 flows toward the rim R, the chance of the air coming into contact with the flange Rb becomes smaller, so the air resistance becomes smaller.

When a distance (a) in the tire axial direction between the axially outermost end 10a of the rim guard 10 and the axially outermost end Re of the flange Rb is excessively large, the air resistance passing through the surface of the rim guard 10 may increase. Thus, the distance (a) is preferably equal to or less than 10 mm, more preferably equal to or less than 5 mm. Further, to protect the flange Rb, the distance (a) is preferably equal to or more than 1 mm.

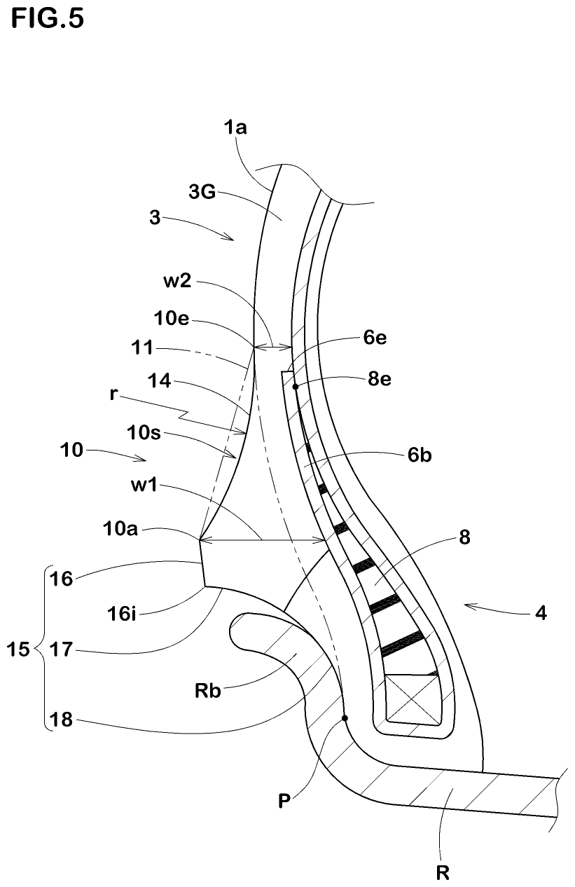

FIG. 5 is a cross-sectional view of the bead portion 4 and the sidewall portion 3 on the left side of FIG. 1. As illustrated in FIG. 5, the rim guard 10, in the present embodiment, includes a rim guard surface 10s that includes an outer surface 14 and an inner surface 15 located inwardly in the tire radial direction of the outer surface 14.

The outer surface 14, for example, extends from the radially outermost end 10e of the rim guard 10 to the axially outermost end 1a of the rim guard 10, and is inclined in a direction axially outwardly toward inside in the tire radial direction. In the present embodiment, the outer surface 14 is formed in a concave circular are surface being concave inwardly in the tire radial direction with respect to the imaginary rim guard straight line 11. Such an outer surface 14 can suppress contact between the air (h) flowing from the outer surface 14 toward the rim R and the rim R when traveling, and prevents air separation on the surface of the rim R. Thus, by increasing the effect of reducing air resistance, fuel efficiency can be improved.

Preferably, a radius of curvature (r) of the concave circular arc surface of the rim guard 10 is in a range of 100 to 300 mm. When the radius of curvature (r) is less than 100 mm, large stress concentration may occur on the outer surface 14, and the rim guard 10 may be damaged. When the radius of curvature (r) is more than 300 mm, the contact between the air (h) flowing from the outer surface 14 side toward the rim R and the rim R may not be effectively suppressed upon traveling. Note that the radius of curvature (r) is an avenge value of the radii of curvature from the axially outermost end 10a of the rim guard 10 to the radially outermost end 10e of the rim guard 10.

The inner surface 15, for example, extends from the axially outermost end 10a of the rim guard 10 to the reference point P. and all or a major part thereof may be inclined axially inwardly toward inside in the tire radial direction. The inner surface 15, in the present embodiment, includes a first portion 16 extending inwardly in the tire radial direction from the axially outermost end 10a of the rim guard 10, a second portion 17 extending inwardly in the tire radial direction from the first portion 16, and a third portion 18 connected to the second portion 17. The first portion 16, for example, extends in a straight shape to have a radially inner end 16i thereof terminating outside in the tire axial direction with respect to the flange Rb. The second portion 17, for example, extends in a concave circular arc shape with a larger inclination angle with respect to the tire radial direction than that of the first portion 16. The second portion 17 is not in contact with the rim R. The third portion 18, for example, is in contact with the rim R, and is connected to the second portion 17 smoothly to form a concave circular arc shape.

In the present embodiment, the rim guard surface 10s is formed in a substantially trapezoidal shape with apexes including the reference point P, the radially inner end 16i, the axially outermost end 10a, and the radially outermost end 10e. Note that the rim guard surface 10s of the rim guard 10 is not limited to such an aspect, but can be a substantially triangular shape with apexes including the reference point P, the axially outermost end 10a of the rim guard 10, and the radially outermost end 10e of the rim guard 10.

Preferably, the axially outermost end 10a of the rim guard 10 is located inside in the tire radial direction with respect to the radially outer end 6e of the turn-up portion 6b. Thus, stiffness of the rim guard 10 is maintained high, and deformation of the rim guard 10 due to the load is suppressed, resulting in reducing the air resistance.

Preferably, the axially outermost end 10a of the rim guard 10 is located inside in the tire radial direction with respect to the radially outer end Se of the bead apex rubber 8. Thus, high stiffness of the rim guard 10 can be maintained to further reduce air resistance.

Outside the radially outermost end 10e of the rim guard 10, a thickness of the sidewall rubber 3G is relatively small. Thus, when the radially outer end 6e of the turn-up portion 6b, for example, is located outside in the tire radial direction with respect to the radially outermost end 10e of the rim guard 10, large stiffness change occurs around the radially outer end 6e of the turn-up portion 6b. Thus, in this part, deformation of the sidewall portion 3 due to the load tends to increase and the air resistance may increase. From this perspective, it is preferable that the radially outermost end 10e of the rim guard 10 is located outside in the tire radial direction with respect to the radially outer end 6e of the turn-up portions 6b. Similarly, the radially outermost end 10e of the rim guard 10 is preferably located outside in the tire radial direction with respect to the radially outer end Se of the bead apex rubber S.

In the present embodiment, the radially outer end 6e of the turn-up portion 6b is located outward in the tire radial direction with respect to a middle position of a radial distance between the axially outermost end 10a and the radially outermost end 10e of the rim guard 10. Further, in the present embodiment, the radially outer end 8e of the bead apex rubber 8 is located outward in the tire radial direction with respect to the middle position of the radial distance between the axially outermost end 10a and the radially outermost end 10e of the rim guard 10.

It is preferable that on the at least one of the bead portions 4, a first gauge w1 of rubber disposed outside in the tire axial direction of the carcass 6 at a location of the axially outermost end 10a of the rim guard 10 is equal to or less than three times a second gauge w2 of rubber disposed outside in the tire axial direction of the carcass 6 at a location of the radially outermost end 10e of the rim guard. This can further enhance the air resistance reduction effect. The gauges w1 and w2 are the thickness of the sidewall rubber 3G in the tire axial direction.

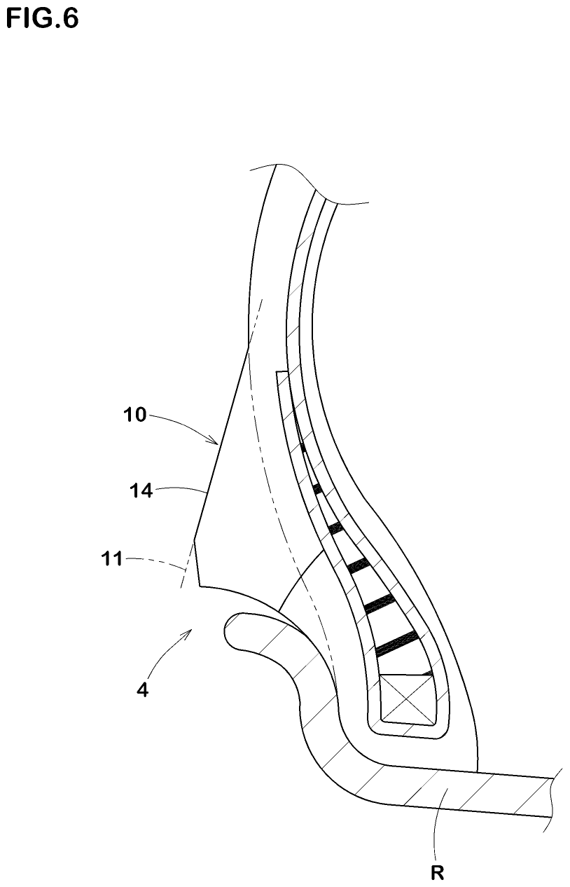

FIG. 6 is a cross-sectional view of the left side bead portion 4 according to another embodiment of the disclosure. In this embodiment, the same elements as those of the embodiment described above are denoted by the same reference numerals and the description thereof will be omitted. As illustrated in FIG. 6, the bead portions 4 according to this embodiment, in a cross-sectional view of the assembly, includes the rim guard 10 with the outer surface 14 that corresponds to the imaginary rim guard straight line 11. In other words, the outer surface 14 extends in a straight shape. Such an outer surface 14 can reduce the air resistance and increase stiffness of the rim guard 10 to prevent its damage, maintaining the air resistance reducing effect for a long time.

While the particularly preferable embodiments in accordance with the present disclosure have been described in detail, the present disclosure is not limited to the illustrated embodiments, but can be modified and carried out in various aspects within the scope of the claims.

### EXAMPLE

Pneumatic tires for passenger cars, 225/40R18, having the basic structure of FIG. 1 were prototyped based on the specifications in Table 1. Then, the fuel efficiency of each test tire was tested. The test method is as follows.

### Fuel Efficiency Test:

The test tires were installed on all wheels of a 2000 cc passenger car under the following conditions. Then, a test driver drove the passenger car to evaluate the fuel efficiency (mileage per one litter of fuel). The test results are shown in Table 1 as an index with Ref. 1 being 100, and the larger the value, the smaller the air resistance and the better.

Mileage: 5000 km

Rim size: 18×6.0 J

Internal pressure: 220 kPa

TABLE 1

| | Ref. 1 | Ref. 2 | Ex. 1 | Ex. 2 | Ex. 3 | Ex. 4 |
|---|---|---|---|---|---|---|
| Maximum gap (A) (mm) | 2.2 | 2.7 | 1.7 | 1.4 | 1.4 | 0.8 |
| Angle θ (deg.) | 45 | 60 | 35 | 30 | 0 | 30 |
| Fuel efficiency | 100 | 95 | 103 | 105 | 103 | 103 |
| [index: larger is better] | | | | | | |

As the test results, it is understood that the example test tires have improved fuel efficiency compared to the comparative example tires.

What is claimed is:

1. A tire and rim assembly comprising:
a rim having a pair of flanges; and
a pneumatic tire being mounted onto the rim, the pneumatic tire comprising a pair of bead portions, a carcass extending between the pair of bead portions, and a rim guard being provided on at least one of the pair of bead portions, wherein
in a cross-sectional view of the assembly under a standard state in which the pneumatic tire is inflated to a standard pressure but loaded with no tire load, the rim guard protrudes outwardly in a tire axial direction from a sidewall reference outer surface of the tire so as to cover over one of the pair of flanges located on the at least one of the bead portions,
the rim guard defines an axially outermost end thereof a radially outermost end thereof, and an imaginary rim guard straight line that passes the axially outermost end and the radially outermost end,
an angle θ of the imaginary rim guard straight line with respect to a tire radial direction is equal to or less than 40 degrees, and
a maximum gap (A) in the tire radial direction between the one of the pair of flanges and the rim guard is equal to or less than 2.0 mm.

2. The tire and rim assembly according to claim 1, wherein
the angle θ is equal to or less than 35 degrees.

3. The tire and rim assembly according to claim 1, wherein
in a cross-sectional view of the assembly, the rim guard comprises a rim guard surface that corresponds to the imaginary rim guard straight line.

4. The tire and rim assembly according to claim 1, wherein
the rim guard comprises a rim guard surface that is a concave circular arc surface being concave inwardly in the tire radial direction with respect to the imaginary rim guard straight line.

5. The tire and rim assembly according to claim 4, wherein
a radius of curvature of the concave circular arc surface of the rim guard is in a range of 100 to 300 mm.

6. The tire and rim assembly according to claim 1, wherein
the maximum gap (A) is equal to or less than 1.5 mm.

7. The tire and rim assembly according to claim 1, wherein
the pair of bead portions comprises a pair of bead cores,
the carcass comprises a main portion extending between the pair of bead cores and a pair of turn-up portions turned up around the pair of bead cores from axially inside to outside of the tire, and
the axially outermost end of the rim guard is located inward in the tire radial direction with respect to a radially outer end of one of the pair of turn-up portions located on a side of the at least one of the bead portions.

8. The tire and rim assembly according to claim 7, wherein
the radially outermost end of the rim guard is located outward in the tire radial direction with respect to the radially outer end of one of the turn-up portions.

9. The tire and rim assembly according to claim 7, wherein
in the at least one of the bead portions, a bead apex rubber that extends outwardly in the tire radial direction from the bead core is disposed, and
the axially outermost end of the rim guard is located inward in the tire radial direction with respect to a radially outer end of the bead apex rubber.

10. The tire and rim assembly according to claim 1, wherein
on the at least one of the bead portions, a first gauge of rubber disposed outside in the tire axial direction of the carcass at a location of the axially outermost end of the rim guard is equal to or less than three times a second gauge of rubber disposed outside in the tire axial direction of the carcass at a location of the radially outermost end of the rim guard.

11. The tire and rim assembly according to claim 2, wherein
in a cross-sectional view of the assembly, the rim guard comprises a rim guard surface that corresponds to the imaginary rim guard straight line.

12. The tire and rim assembly according to claim 2, wherein
the rim guard comprises a rim guard surface that is a concave circular arc surface being concave inwardly in the tire radial direction with respect to the imaginary rim guard straight line.

13. The tire and rim assembly according to claim 1, wherein
the rim guard comprises a flat plane that extends inwardly in the tire radial direction from the axially outermost end, and
the flat plane is inclined inwardly in the tire axial direction toward radially inwardly.

14. The tire and rim assembly according to claim 1, wherein
the pneumatic tire further comprises a sidewall rubber that is disposed outwardly in the tire axial direction of the carcass on a sidewall portion of the at least one of the pair of bead portions, and
the sidewall rubber extends toward the at least one of the pair of bead portions so as not to contact with the rim.

15. The tire and rim assembly according to claim 14, wherein
the sidewall rubber has a radially inner end exposed at an axially outer surface of the at least one of the pair of bead portions, and
in the at least one of the pair of bead portions, a maximum radial distance from a radially outermost point of the rim flange to the axially inner end of the sidewall portion is smaller than the maximum gap (A).

16. The tire and rim assembly according to claim 15, wherein
the radially inner end of the sidewall rubber is located outwardly in the tire radial direction with respect to the radially outermost point of the rim flange.

17. The tire and rim assembly according to claim 8, wherein
in the at least one of the bead portions, a bead apex rubber that extends outwardly in the tire radial direction from the bead core is disposed, and
the axially outermost end of the rim guard is located inward in the tire radial direction with respect to a radially outer end of the bead apex rubber.

18. The tire and rim assembly according to claim 6, wherein
on the at least one of the bead portions, a first gauge of rubber disposed outside in the tire axial direction of the carcass at a location of the axially outermost end of the rim guard is equal to or less than three times a second gauge of rubber disposed outside in the tire axial direction of the carcass at a location of the radially outermost end of the rim guard.

19. A tire and rim assembly comprising:
a rim having a pair of flanges; and
a pneumatic tire being mounted onto the rim, the pneumatic tire comprising a pair of bead portions, a carcass extending between the pair of bead portions, and a rim guard being provided on at least one of the pair of bead portions; wherein
in a cross-sectional view of the assembly under a standard state in which the pneumatic tire is inflated to a standard pressure but loaded with no tire load, the rim guard protrudes outwardly in a tire axial direction from a sidewall reference outer surface of the tire so as to cover over one of the pair of flanges located on the at least one of the bead portions,
the rim guard defines an axially outermost end thereof, a radially outermost end thereof and an imaginary rim guard straight line that passes the axially outermost end and the radially outermost end,
an angle θ of the imaginary rim guard straight line with respect to a tire radial direction is equal to or less than 40 degrees,
a maximum gap (A) in the tire radial direction between the one of the pair of flanges and the rim guard is equal to or less than 2.0 mm,
in a cross-sectional view of the assembly, the rim guard comprises a rim guard surface that corresponds to the imaginary rim guard straight line,
the pair of bead portions further comprises a pair of bead cores,
the carcass comprises a main portion extending between the pair of bead cores and a pair of turn-up portions turned up around the pair of bead cores from axially inside to outside of the tire,
the axially outermost end of the rim guard is located inward in the tire radial direction with respect to a radially outer end of one of the pair of turn-up portions located on the at least one of the bead portions,
the radially outermost end of the rim guard is located outward in the tire radial direction with respect to the radially outer end of one of the turn-up portions,
in the at least one of the bead portions, a bead apex rubber that extends outwardly in the tire radial direction from the bead core is disposed,
the axially outermost end of the rim guard is located inward in the tire radial direction with respect to a radially outer end of the bead apex rubber, and
on the at least one of the bead portions, a first gauge of rubber disposed outside in the tire axial direction of the carcass at a location of the axially outermost end of the rim guard is equal to or less than three times a second gauge of rubber disposed outside in the tire axial direction of the carcass at a location of the radially outermost end of the rim guard.

20. A tire and rim assembly comprising:
a rim having a pair of flanges; and
a pneumatic tire being mounted onto the rim, the pneumatic tire comprising a pair of bead portions, a carcass extending between the pair of bead portions, and a rim guard being provided on at least one of the pair of bead portions; wherein
in a cross-sectional view of the assembly under a standard state in which the pneumatic tire is inflated to a standard pressure but loaded with no tire load, the rim guard protrudes outwardly in a tire axial direction from a sidewall reference outer surface of the tire so as to cover over one of the pair of flanges located on the at least one of the bead portions,
the rim guard defines an axially outermost end thereof, a radially outermost end thereof and an imaginary rim guard straight line that passes the axially outermost end and the radially outermost end,
an angle θ of the imaginary rim guard straight line with respect to a tire radial direction is equal to or less than 40 degrees,
a maximum gap (A) in the tire radial direction between the one of the pair of flanges and the rim guard is equal to or less than 2.0 mm,
the rim guard comprises a rim guard surface that is a concave circular are surface being concave inwardly in the tire radial direction with respect to the imaginary rim guard straight line,
a radius of curvature of the concave circular are surface of the rim guard is in a range of 100 to 300 mm,
the pair of bead portions further comprises a pair of bead cores,
the carcass comprises a main portion extending between the pair of bead cores and a pair of turn-up portions turned up around the pair of bead cores from axially inside to outside of the tire,
the axially outermost end of the rim guard is located inward in the tire radial direction with respect to a radially outer end of one of the pair of turn-up portions located on the at least one of the bead portions,
the radially outermost end of the rim guard is located outward in the tire radial direction with respect to the radially outer end of one of the turn-up portions,
in the at least one of the bead portions, a bead apex rubber that extends outwardly in the tire radial direction from the bead core is disposed,
the axially outermost end of the rim guard is located inward in the tire radial direction with respect to a radially outer end of the bead apex rubber, and
on the at least one of the bead portions, a first gauge of rubber disposed outside in the tire axial direction of the carcass at a location of the axially outermost end of the rim guard is equal to or less than three times a second gauge of rubber disposed outside in the tire axial direction of the carcass at a location of the radially outermost end of the rim guard.
